(19) United States
(12) Patent Application Publication
(10) Pub. No.: US 2025/0110778 A1
(43) Pub. Date: Apr. 3, 2025

(54) HETEROGENEOUS SCHEDULING FOR PROCESSORS WITH MULTIPLE CORE TYPES

(71) Applicant: Microsoft Technology Licensing, LLC, Redmond, WA (US)

(72) Inventors: Aobo GUAN, Redmond, WA (US); Tristan Anthony BROWN, Houston, TX (US); Tapan ANSEL, Redmond, WA (US)

(73) Assignee: Microsoft Technology Licensing, LLC, Redmond, WA (US)

(21) Appl. No.: 18/428,908

(22) Filed: Jan. 31, 2024

Related U.S. Application Data
(60) Provisional application No. 63/586,429, filed on Sep. 29, 2023.

(51) Int. Cl. G06F 9/48; G06F 9/50

(52) U.S. Cl. CPC G06F 9/4893; G06F 9/5027; G06F 9/5094; G06F 2209/5018

(57) ABSTRACT

Examples of the present disclosure describe systems and methods for heterogeneous scheduling for processors with multiple core types. In some examples, a scheduler assigns thread policies to respective threads. The scheduler then allocates the threads to heterogeneous cores in accordance with the thread policies assigned to the respective threads. The heterogeneous cores include one or more power efficient cores, one or more intermediate cores, and one or more performance-oriented cores, among other core types. In some examples, a core parking engine determines how many cores should be unparked for one or more power efficient cores, one or more intermediate cores, and one or more performance-oriented cores, among other core types.

### CROSS-REFERENCE TO RELATED APPLICATIONS

This application claims the benefits of U.S. Provisional Application No. 63/586,429 filed Sep. 29, 2023, entitled “Heterogenous Scheduling for Processors with Multiple Core Types,” which is incorporated herein by reference in its entirety.

### BACKGROUND

Heterogeneous computing involves using different types of processor cores within the same system for various tasks to optimize performance and power efficiency. The concept of “big and little” cores pairs high-performance, power-hungry cores with power-efficient, less powerful cores. Heterogeneous scheduling is a strategy where tasks are allocated to either “big” or “little” cores based on their computational demands, aiming to balance performance and power consumption.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe heterogeneous scheduling for processors with multiple core types.

In some examples, a scheduler assigns thread policies to respective threads. The thread policies specify criteria for allocating the threads to heterogeneous processor cores (“cores”) of a processing system. The criteria for the thread allocation includes, among other aspects, a lower threshold of the heterogeneous cores, an upper threshold of the heterogeneous cores, and an optimization metric. The heterogeneous cores include one or more power efficient cores, one or more intermediate cores, and one or more performance-oriented cores. In some examples, the heterogeneous cores additionally include one or more enhanced performance-oriented cores. The optimization metric indicates the type of core (e.g., power efficiency, intermediate, or performance-oriented) preferred for each of the threads. The scheduler then allocates the threads to the heterogeneous cores in accordance with the thread policies assigned to the respective threads.

In some examples, a core parking engine analyzes one or more system utilization metrics. Based on the one or more system utilization metrics, the core parking engine determines a first core count, which represents a total number of cores to be unparked. The core parking engine determines, from multiple processor threads, a first percentage of the multiple processor threads that have thread policies biased for cores that are higher performance than power efficient cores. Based on the first percentage of the multiple processor threads, the core parking engine determines a second core count, which represents a number of cores to be unparked that are higher performance than power efficient cores. The core parking engine determines a third core count, which represents a number of power efficient cores to be unparked, by subtracting the second core count from the first core count. The core parking engine determines a second percentage of the first percentage of the multiple processed threads that have thread policies biased for cores that are higher performance than intermediate cores. Based on the second percentage of the multiple processor threads, the core parking engine determines a fourth core count, which represents a number of cores to be unparked that are higher performance than intermediate cores. The core parking engine determines a fifth core count, which represents a number of intermediate cores to be unparked, by subtracting the fourth core count from the second core count. The core parking engine then unparks one or more cores based at least in part on the third core count, the fourth core count, and/or the fifth core count. Although the above example describes determinations made by the core parking engine with respect to three-core scenarios (e.g., processors comprising three different core types), as described elsewhere in this disclosure, it is contemplated that the determinations made by the core parking engine are equally applicable to scenarios involving four or more core types.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example system diagram that implements heterogeneous scheduling for processors with multiple core types in accordance with examples described herein.

FIG. 2 illustrates an example diagram of determining a number of cores to unpark (or park) in accordance with examples described herein.

FIG. 3 illustrates an example diagram of quality of service (QOS) levels and corresponding optimization metrics in accordance with examples described herein.

FIG. 4 illustrates a method flow for determining a number of cores to unpark (or park) in a system having processors with multiple core types in accordance with examples described herein.

FIG. 5 illustrates a method flow for heterogeneous scheduling for processors with multiple core types in accordance with examples described herein.

FIG. 6 illustrates a block diagram including physical components of a computing device in accordance with examples described herein.

### DETAILED DESCRIPTION

Heterogeneous computing involves using different types of processor cores within the same system for various tasks to optimize performance and power efficiency. The concept of “big and little” cores pairs high-performance, power-hungry cores (e.g., big cores) with power efficient, less powerful cores (e.g., little cores). Heterogeneous scheduling is a strategy where tasks are allocated to either big or little cores based on their computational demands, aiming to balance speed and power consumption. In some cases, there may be three or more core types. For example, a system may include little cores, big cores, and “prime” cores (e.g., enhanced performance-oriented cores). However, heterogeneous scheduling for two core types is not directly translatable to heterogeneous scheduling for three or more core types. Thus, a solution for heterogeneous scheduling for three or more core types is desired. It should be noted that the nomenclature used to describe these three or more core types is malleable, and that the purpose is merely to distinguish in some fashion between three or more different core types that have different properties, capabilities, and the like. As such, different or generalized core types may be substituted for these core types without departing from the scope of the present disclosure (e.g., a first core type, a second core type, a third core type, a fourth core type).

In accordance with examples described herein, the present application provides systems and methods for heterogeneous scheduling for processors with multiple core types. In some examples, a scheduler assigns thread policies to respective threads. A thread refers to a unit of execution indicating a sequence of instructions. The thread policies specify criteria for allocating the threads to heterogeneous cores of a processing system. The criteria for the thread allocation includes, among other aspects, a lower threshold of the heterogeneous cores, an upper threshold of the heterogeneous cores, and an optimization metric. The heterogeneous cores include one or more power efficient cores, one or more intermediate cores, and one or more performance-oriented cores. In some examples, the heterogeneous cores additionally include one or more enhanced performance-oriented cores. The optimization metric indicates the type of core (e.g., power efficiency, intermediate, or performance-oriented) preferred for each of the threads. The scheduler then allocates the threads to the heterogeneous cores in accordance with the thread policies assigned to the respective threads.

In some examples, a core parking engine analyzes one or more system utilization metrics. Based on the one or more system utilization metrics, the core parking engine determines a first core count, which represents a total number of cores to be unparked. The core parking engine determines, from multiple processor threads, a first percentage of the multiple processor threads that have thread policies biased for cores that are higher performance than power efficient cores. Based on the first percentage, the core parking engine determines a second core count, which represents a number of cores to be unparked that are higher performance than power efficient cores. The core parking engine determines a third core count, which represents a number of power efficient cores to be unparked, by subtracting the second core count from the first core count. The core parking engine determines a second percentage of the first percentage of the multiple processed threads that have thread policies biased for cores that are higher performance than intermediate cores. Based on the second percentage, the core parking engine determines a fourth core count, which represents a number of cores to be unparked that are higher performance than intermediate cores. The core parking engine determines a fifth core count, which represents a number of intermediate cores to be unparked, by subtracting the fourth core count from the second core count. The core parking engine then unparks one or more cores based at least in part on the third core count, the fourth core count, and/or the fifth core count.

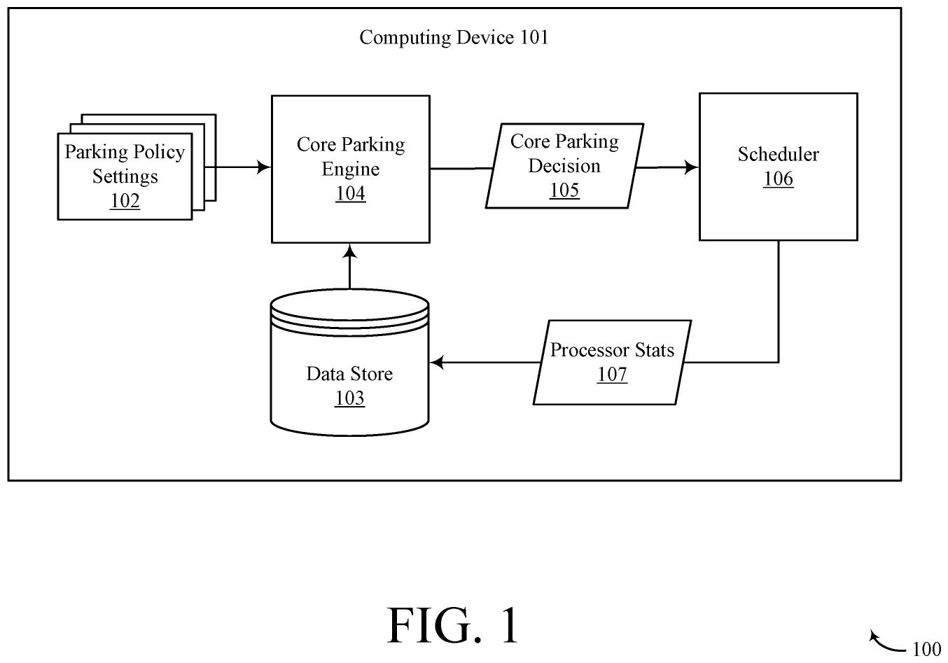

FIG. 1 illustrates a system that implements heterogeneous scheduling for processors with multiple core types. System 100, as presented, includes a combination of interdependent components that interact to form an integrated whole. Components of system 100 include hardware components or software components (e.g., application programming interfaces (APIs), modules, runtime libraries) implemented on and/or executed by hardware components of system 100. In some examples, components of system 100 are distributed across multiple processing devices or computing systems.

System 100 includes computing device 101, parking policy settings 102, data store 103, core parking engine 104, core parking decision 105, scheduler 106, and processor statistics 107. The scale and structure of devices and environments discussed herein may vary and may include additional or fewer components than those described in FIG. 1 and subsequent figures. Further, although examples in FIG. 1 and subsequent figures will be described in the context of systems utilizing three or four types of cores, the examples are equally applicable to systems utilizing any number of core types.

Computing device 101 represents a computer (e.g., a personal computer (“PC”), a laptop, or a server device), a mobile device (e.g., smartphone or a tablet), or any other type of electronic processing device. Computing device 101 uses one or more processors (e.g., central processing units (CPUs), graphical processing units (GPUs), or tensor processing units (TPUs) to execute instructions and perform tasks. The one or more processors each have one or more cores, which are individual processing units capable of running tasks. The one or more cores may be different core types (e.g., power efficient cores, intermediate cores, performance-oriented cores, enhanced performance-oriented cores). Power efficient cores are intended to consume less power than more performant core types and often provide lower performance (e.g., slower processing speed) than more performant core types. Intermediate cores are intended to use balanced approach to power consumption and performance such that intermediate cores consume less power than more performant core types and provide higher performance (e.g., higher processing speed) than more power efficient core types. Performance-oriented cores are intended to provide higher performance (e.g., higher processing speed) than more power efficient core types and often consume more power than less power efficient core types. Enhanced performance-oriented cores are intended to provide even higher performance (e.g., higher processing speed) than performance-oriented cores and often consume even more power than performance-oriented cores. Computing device 101 may run an operating system to, for example, manage hardware resources, such as the one or more cores, and make them accessible to software applications. For example, the operating system runs core parking engine 104 and scheduler 106, which manage the one or more cores and threads that are assigned to them, as will be discussed.

Parking policy settings 102 determine how and when cores should be parked or unparked based on the current workload and performance needs (e.g., battery levels, temperature, and usage spikes at certain times of the day) of a system (e.g., computing device 101). Parking a core refers to disabling a core to save power, while unparking a core refers to enabling a core for use. In some examples, parking policy settings 102 include battery level-based parking policies. For instance, when the battery level for computing device reaches a certain threshold (e.g., 25%, 10%, 5%), some cores may be parked to conserve power. In other examples, parking policy settings 102 include temperature-based parking policies. For instance, if internal temperatures of computing device 101 rise above a certain threshold (e.g., 80 degrees or 90 degrees Celsius), some cores may be parked to reduce heat and protect components of computing device 101. In some other examples, parking policy settings 102 include usage spike-based parking policies. For instance, during predictable daily usage spikes, computing device 101 may unpark some cores to handle anticipated workloads. In other examples, parking policy settings 102 include reactive policies. For instance, reactive policies allow computing device 101 to adjust core parking in real-time based on sudden changes in the system utilization of computing device 101. In other examples, parking policy settings 102 include user preferences and overrides. For instance, user preferences offer the option to override automated core parking decisions for specific scenarios. Additional or alternative parking policy settings 102 that determine how and when cores should be parked or unparked based on the current workload and performance needs are contemplated.

Data store 103 acts as a repository that stores processor statistics 107 provided from scheduler 106. Examples of data store 103 include data tables, databases, and file systems. Data store 103 accumulates one or more metrics related to, for example, usage patterns, workload characteristics of a workload (where a workload represents the number of instructions or threads being executed by a system, processor, or core at or over a period of time), and performance of cores. For example, data store 103 may store data about utilization rates of cores (e.g., active and/or idle times), task queue lengths, pending tasks, clock frequencies (e.g., core speed), thermal metrics (e.g., core temperature), and/or types and priorities of tasks that each core handles. In some examples, data store 103 also stores an indicator (e.g., a flag or a parameter) that is assigned to the core to indicate whether the core is currently parked. For instance, data store 103 may maintain a table or other data structure of real-time parking states (e.g., parked or unparked) for each core in a system. Core parking engine 104 accesses data store 103 to retrieve processor statistics 107, among other information. Processor statistics 107 enable core parking engine 104 to determine which cores to park or unpark. For example, if a core shows low system utilization and is frequently idle, core parking engine 104 may decide to park that core to conserve power. Conversely, if an unparked core shows high system utilization, core parking engine 104 may decide to unpark a currently parked core to improve performance.

Core parking engine 104 represents functionality operable to assess system-wide power management considerations and manage the availability of processors and cores based on the assessment. In examples, this involves analyzing factors including the overall workload, thermal conditions, user presence, processor/core utilization, level of concurrent use of processors/cores (“concurrency”), application context, device context, priority, contextual clues, parking policy settings 102, information from data store 103 (e.g., processor statistics 107), system utilization metrics, hardware topology, and other performance metrics that may be used to perform power management decisions at the system level. Core parking engine 104 applies power management policies to adjust the performance of the computing device 101 based on the assessment of system-wide performance metrics and conditions. This may involve controlling the states and/or availability of cores of computing device 101. For example, core parking engine 104 may selectively set an unused core or a core having low utilization in a low power state, such as a parked state or a restricted access state (e.g., the core is only accessible under certain conditions) and set a parked core in a high power state, such as an unparked mode, when currently unparked cores are experiencing a high workload. Core parking engine 104 may also communicate indications regarding the parking and unparking of cores to other components to convey the availability of the cores to do work until the next assessment. As one example, core parking engine 104 communicates such indications to scheduler 106 in the form of core parking decision 105. However, in another example in which scheduler 106 is not active (or is not included within system 100), core parking engine 104 does not communicate core parking decision 105 to scheduler 106.

Core parking decision 105 is a communication from core parking engine 104 to scheduler 106 that indicates which cores to unpark and park. In some examples, a data structure representing the core parking decision is organized in an array or a list where each element corresponds to a core. Each element may contain a core ID (e.g., an identifier for the core), a core state (e.g., parked, restricted access, or unparked), a core priority (e.g., indicates the importance of changing the core's state, where a high value indicates an urgent need to unpark or park the core), and a decision timestamp (e.g., when the core parking decision 105 was made by the core parking engine 104).

Scheduler 106 represents functionality operable to manage the allocation of a workload across available processors and/or cores. This management encompasses tasks such as queuing, scheduling, prioritizing, and dispatching threads across available processors and/or cores. Scheduler 106 makes high-frequency, thread-by-thread placement decisions to allocate the workload across the cores of the processing system in adherence with thread-specific policies. In some examples, the thread-by-thread placement decisions are influenced by core parking engine 104. For instance, the placement of threads might be restricted to a specific subset of the cores based on system-wide power management assessments conducted by core parking engine 104. In other examples, the thread-by-thread placement decisions are made independent of core parking decision 105 or any information that may be received from core parking engine 104. For instance, even if core parking engine 104 is not active (or is not included within system 100), scheduler 106 makes decisions to place threads on currently unparked cores of the system. As illustrated, core parking engine 104 and scheduler 106 may be configured as separate, standalone components or modules. Alternatively, core parking engine 104 and scheduler 106 may be combined and/or implemented as a single component.

Processor statistics 107 are provided by scheduler 106 to data store 103. In some examples, additional or alternative components or modules provide processor statistics to data store 103. Processor statistics 107 may include one or more system utilization metrics, such as usage patterns, workload characteristics, processor concurrency, and performance of cores. For example, processor statistics 107 include utilization rates, idle times, task queue lengths, clock frequencies, thermal metrics, and/or types and priorities of tasks that each core handles.

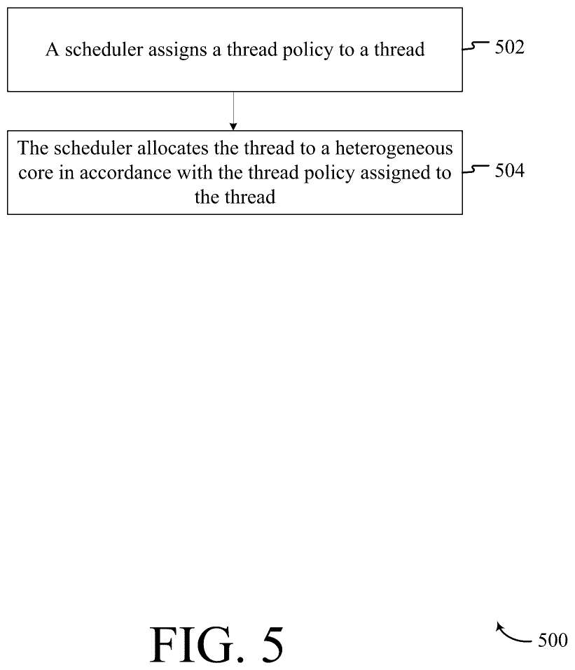

Scheduler 106 also provides information (e.g., including thread policy information) to data store 103 about the threads that it schedules among unparked cores. For example, such information may include a thread ID (e.g., an identifier for a thread), a quality of service (QOS) level (e.g., indicating preferences between performance and power efficiency for a thread), a specific type of core (e.g., power efficient cores, intermediate cores, performance-oriented cores) to which a thread is scheduled (e.g., allocated), an expected duration of execution for a thread, a priority level of a thread, a current state of a thread (e.g., running, waiting, blocked, or terminated), and historical execution metrics for a thread (e.g., average run time or average wait time). Data store 103 may store this information and provide it to core parking engine 104. Core parking engine 104 may analyze this information to, for example, determine percentages of threads that are biased for certain cores, as will be discussed further in FIG. 5.

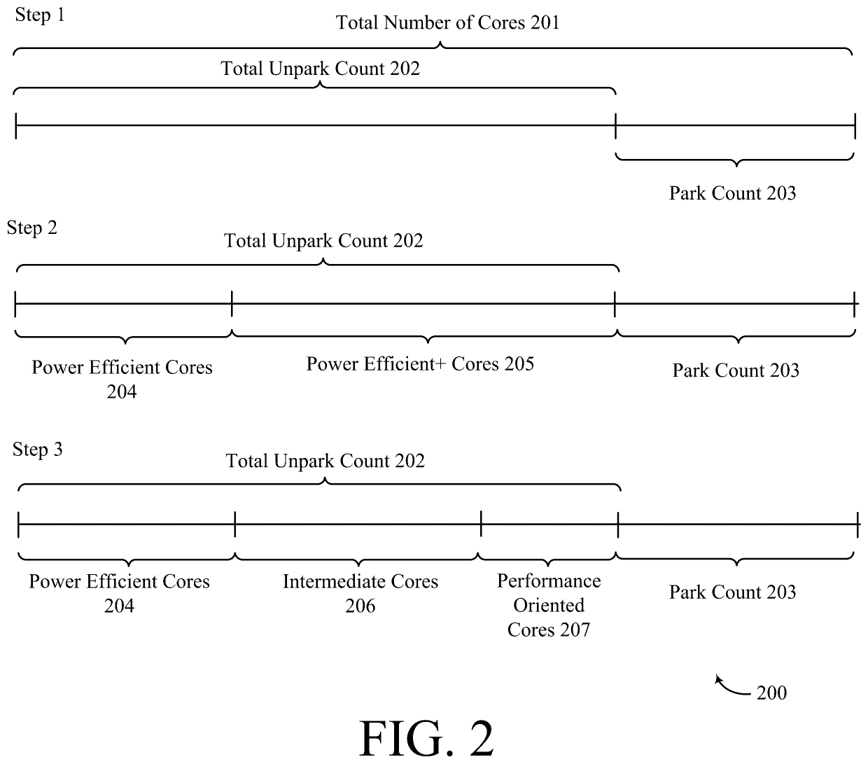

FIG. 2 illustrates an example diagram of determining a number of cores to unpark (or park) in accordance with examples described herein. Diagram 200 is a representation of steps taken by core parking engine 104 to determine the number of each core type (e.g., power efficient cores, intermediate cores, performance-oriented cores) to be unparked.

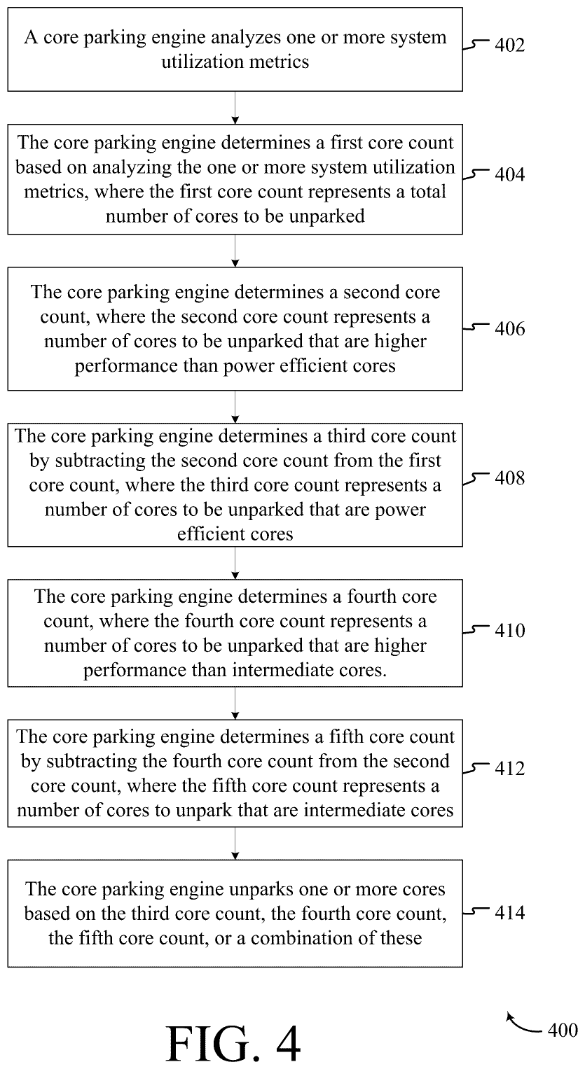

At step 1, core parking engine 104 determines the number of total cores to be unparked and parked (e.g., total unpark count 202 and park count 203, respectively). Core parking engine 104 analyzes one or more system utilization metrics to make this determination, as will be discussed in FIG. 4. A total number of cores 201 is already known, and a total number of cores to be unparked, or total unpark count 202, is determined by analyzing the one or more system utilization metrics. The parked count 203 is determined by subtracting the total unpark count 202 from the total number of cores 201.

At step 2, core parking engine 104 splits the total unpark count 202 into two groups-power efficient cores 204 and power efficient+ cores 205. Power efficient+ cores 205 are more performant that power efficient cores 204 and refer to a group of cores that comprises intermediate cores 206 and performance-oriented cores 207. Core parking engine 104 determines the number of power efficient cores 204 to unpark. The way core parking engine 104 arrives at this determination is further discussed in FIG. 4.

At step 3, core parking engine 104 splits the power efficient+ cores 205 into two groups—intermediate cores 206 and performance-oriented cores 207. Core parking engine 104 determines the number of intermediate cores 206 and performance-oriented cores 207 to unpark. The way core parking engine 104 arrives at this determination is further discussed in FIG. 4.

Although FIG. 2 illustrates operations of core parking engine 104 in the context of three core types, the operations of operations of core parking engine 104 are equally applicable in the context of more than (or less than) three core types, as will be described in FIG. 4.

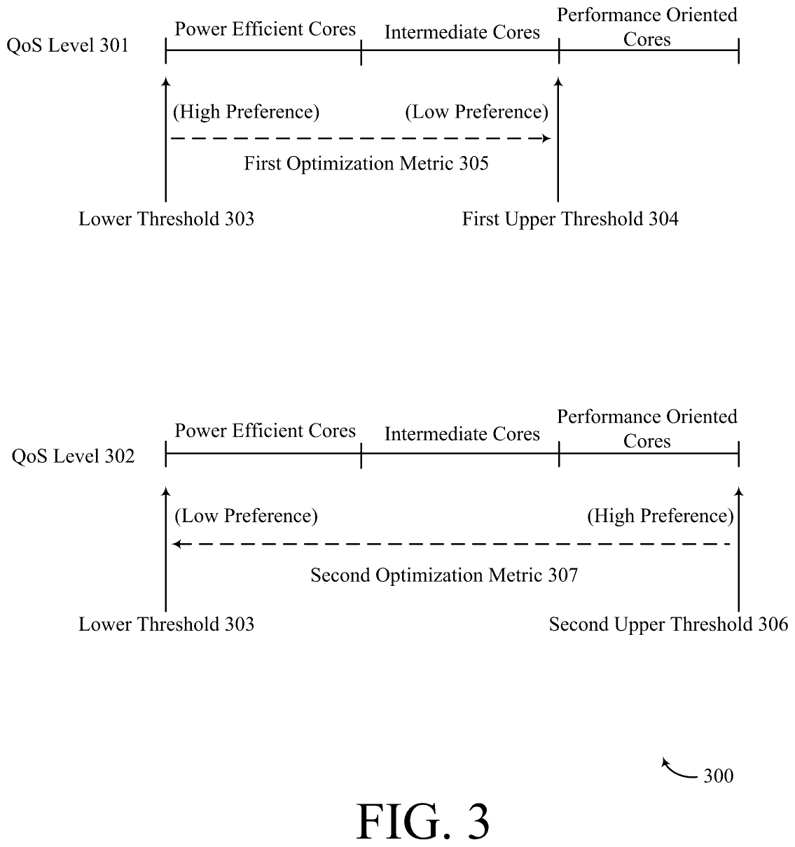

FIG. 3 illustrates an example diagram of QoS levels and corresponding optimization metrics in accordance with examples described herein. Diagram 300 is a representation of example QoS levels that are assigned to individual threads, and which are considered by scheduler 106 when scheduling threads among heterogeneous cores.

Diagram 300 includes QoS level 301 and QoS level 302. In examples, different QoS levels are associated with different lower threshold core types, upper threshold core types, and/or optimization metrics. For instance, QoS level 301 is associated with lower threshold 303, first upper threshold 304, and first optimization metric 305. QoS level 302 is associated with lower threshold 303, second upper threshold 306, and second optimization metric 307. The lower and upper thresholds are the bounds for potential core types to which a thread may be allocated. Optimization metrics indicate a preferred core type or execution bias (e.g., whether there is a bias and/or the amount of bias towards power efficiency or performance) of a thread assigned to a core by scheduler 106.

QOS level 301 is associated with a power efficient QoS level. For threads with power efficiency QoS levels, computing device 101 selects a core having a power efficient clock frequency (e.g., a clock frequency in the megahertz (MHz) range or in a range below that of more performant cores) and schedules threads to that power efficient core. QoS level 301 is associated with lower threshold 303, which designates power efficient cores, and first upper threshold 304, which designates intermediate cores. QoS level 301 is also associated with first optimization metric 305, which designates an execution bias for QoS level 301. Specifically, first optimization metric 305 indicates a strong execution bias (e.g., a high preference) towards power efficient cores and a lesser execution bias (e.g., a lesser preference) towards intermediate cores. As first upper threshold 304 prevents or recommends against scheduling threads to performance-oriented cores, first optimization metric 305 may indicate an even lesser execution bias (e.g., a minimal preference, no preference, or an aversion) towards performance-oriented cores.

QOS level 302 is associated with a high performance QoS level. For threads with high performance QoS levels, computing device 101 selects a core having a performant CPU frequency (e.g., a clock frequency in the gigahertz (GHz) range or in a range above that of more power efficient cores) and schedules threads to that performance-oriented core. QoS level 302 is associated with lower threshold 303, which designates power efficient cores, and second upper threshold 306, which designates performance-oriented cores. QoS level 301 is also associated with second optimization metric 307, which designates an execution bias for QoS level 301. Specifically, second optimization metric 307 indicates a strong execution bias towards performance-oriented cores, a lesser execution bias towards intermediate cores, and an even lesser execution bias towards power efficient cores.

Scheduler 106 allocates threads to unparked cores based on thread policy information, which includes QoS levels 301 and 302. For example, scheduler 106 schedules a thread with QoS level 301 to a power efficient core. However, if there are no power efficient cores available, scheduler 106 schedules the thread to an intermediate core, which may be the next best core type for that thread given its associated QoS level.

It should be noted that while two QoS levels are illustrated (e.g., high power efficiency QoS and high performance QoS), other QoS levels may be contemplated, such as a medium performance QoS (e.g., lower performance than the high performance QoS), a medium power efficiency QoS (e.g., lower power efficiency than the high power efficiency QoS), a selectively high power efficiency QoS (e.g., high power efficiency in certain conditions, such as when battery level is low or a device is on battery), and a selectively high performance QOS (e.g., high power performance in certain conditions, such as when battery level is high or to meet a specified deadline. In examples, each QoS level has a respective configuration (e.g., lower threshold, upper threshold, and optimization metric) that may be different than other QoS levels.

FIG. 4 illustrates an example method for determining a number of cores to unpark (or park) in a system having processors with multiple core types. The method 400 may be performed by the system(s) described herein and/or the components of such system(s). For instance, the method 400 may be performed by computing device 101 and/or the components thereof (e.g., core parking engine 104).

At step 402, a core parking engine (e.g., core parking engine 104) analyzes one or more system utilization metrics. The system utilization metrics include, for example, a workload of a system, concurrency data, a runqueue length, a power plan setting, a battery state, a user input, a system temperature, a core clock speed, a hardware hint, a number of threads processed by cores over a time period, or substantially any metric other related to the state of computing device 101 or its components. Concurrency data indicates information about the number of cores working simultaneously in computing device 101. For example, concurrency data includes the amount of time spent running at each concurrency level (e.g., running with zero cores, one core, or two cores), the cumulative percentage of time spent at each concurrency level, and/or an average of the cumulative percentages as a value. The core parking engine uses this information in determining whether computing device 101 is running with a suitable number of unparked cores at or during a certain time period. In this context, a suitable number of unparked cores may refer to one or more cores running at or below a predefined utilization level. In at least one example, concurrency data includes or is represented by a histogram. For instance, in a system having eight cores, the histogram includes labels for nine columns (e.g., corresponding to concurrency levels zero through eight). Each column may include a percentage (or another number or indicator) of time spent running at a respective concurrency level. In some examples, the concurrency level having a cumulative percentage that is closest to the average of the cumulative percentages determines the number of cores to be unparked in total, which is determined in step 404.

Runqueue length indicates the number of processes or threads that are currently waiting in line to be executed by a processor or core of computing device 101. A power plan setting is a predefined configuration of the operating system of computing device 101 that adjusts power consumption and performance parameters of the operating system in response to performance-based scenarios (e.g., an unexpected spike in system utilization) and/or power efficiency-based scenarios (e.g., low battery level of computing device 101 or a component thereof). Battery level refers to the current status of computing device 101's battery, which can include its charge level, health, and/or whether computing device 101 is charging or discharging. User input refers to any commands or actions initiated by a user, such as keystrokes, mouse clicks, or touch gestures. System temperature provides a measure of the internal temperature level of computing device 101. Core clock speeds refer to the frequency at which a core or multiple cores of computing device 101 operate, typically measured in gigahertz (GHz) or megahertz (MHz). Hardware hints include information about hardware of computing device 101, e.g., about the number and/or type of cores of computing device 101.

At step 404, core parking engine 104 determines a first core count based on analyzing the one or more system utilization metrics, where the first core count represents a total number of cores to be unparked (e.g., 202). This determination is made based at least in part on the concurrency data previously discussed, among other system utilization data. After step 404, core parking engine 104 may determine, from a plurality of threads processed by cores, a first percentage of threads (analyzed in the system utilization metrics) that have thread policies biased for cores that are higher performance than power efficient cores. Cores that are higher performance than power efficient cores include intermediate cores, performance-oriented cores, and enhanced performance-oriented cores (e.g., power efficient+ cores 205). Core parking engine 104 determines the core types preferred by threads by analyzing a thread policy for the thread. For example, core parking engine 104 may analyze optimization metrics, thread categories, and QoS level, among other data.

At step 406, core parking engine 104 determines a second core count (e.g., based on determining the first percentage of threads), where the second core count represents a number of cores to be unparked that are higher performance than power efficient cores. That is, core parking engine 104 applies the first percentage to the first core count (total number of cores to be unparked) to determine the second core count.

At step 408, core parking engine 104 determines a third core count by subtracting the second core count from the first core count, where the third core count represents a number of cores to be unparked that are power efficient cores (e.g., power efficient cores 204). As core parking engine 104 has already determined the total number of cores that should be unparked at step 404 (the first core count) and the number of cores that should be unparked that are higher performance than power efficient cores at step 406 (the second core count), core parking engine 104 can determine the number of power efficient cores to unpark by subtracting the second core count from the first core count. After step 408, core parking engine 104 may determine, from the first percentage of threads, a second percentage of threads of the first percentage of threads that have thread policies biased for cores that are higher performance than intermediate cores. Cores that are higher performance than intermediate cores (e.g., intermediate+ cores) include performance-oriented cores and enhanced performance-oriented cores.

At step 410, core parking engine 104 determines a fourth core count (e.g., based on determining the second percentage of threads), where the fourth core count represents a number of cores to be unparked that are higher performance than intermediate cores. That is, core parking engine 104 applies the second percentage to the second core count (intermediate+ cores) to determine the fourth core count. In cases where there are only three core types, the fourth core count is the number of performance-oriented cores (e.g., performance-oriented cores 207).

At step 412, core parking engine 104 determines a fifth core count by subtracting the fourth core count from the second core count, where the fifth core count represents a number of cores to unpark that are intermediate cores (e.g., intermediate cores 206). As core parking engine 104 has already determined the second core count and the fourth core count, core parking engine 104 can determine the number of intermediate cores to be unparked by subtracting the fourth core count from the second core count.

In embodiments where there are more than three core types (e.g., four core types, including enhanced performance-oriented cores), core parking engine 104 determines, from the second percentage of threads, a third percentage of threads of the second percentage of threads that have thread policies biased for enhanced performance-oriented cores. Core parking engine 104 then determines a sixth core count (e.g., based on determining the third percentage of threads), where the sixth core count represents a number of cores to be unparked that are enhanced performance-oriented cores. Core parking engine 104 then determines a seventh core count by subtracting the sixth core count from the fourth core count, where the seventh core count represents a number of cores to unpark that are performance-oriented cores. As core parking engine 104 has already determined the fourth core count and the sixth core count, core parking engine 104 can determine the number of performance-oriented cores to be unparked by subtracting the sixth core count from the fourth core count.

In examples, core parking engine 104 further determines one or more core counts for actual unparked cores of a system. An actual unparked core refers to a core that is currently not parked by a system. In contrast, the core counts determined above (i.e., the first core count through the seventh core count) refer to currently parked cores that are to be unparked. The counts of actual unparked cores include an actual power efficient unparked cores count, an actual intermediate unparked cores count, an actual performance-oriented cores count, and an actual enhanced performance-oriented cores count. In some examples, core parking engine 104 determines the count for actual unparked cores based on the system utilization metrics for the system (e.g., usage patterns, workload characteristics, processor concurrency, and performance of cores). For instance, core usage patterns indicating that a core is currently idle and has been continuously idle for a predetermined amount of time (e.g., one hour or one day) may be indicative of a core that is currently parked. Alternatively, the system utilization metrics may include (or core parking engine 104 may separately store) an indicator (e.g., a flag or a parameter) that is assigned to the core to indicate whether the core is currently parked.

At step 414, core parking engine 104 unparks one or more cores based on the third core count, the fourth core count, and/or the fifth core count among other information (e.g., the sixth and seventh counts in four core type scenarios). For example, core parking engine 104 unparks (or parks) one or more power efficient cores based at least in part on a difference between the third core count and the actual power efficient unparked cores count, unparks (or parks) one or more intermediate cores based at least in part on a difference between the fifth core count and the actual intermediate unparked cores count, and unparks (or parks) one or more cores with higher performance than intermediate cores (e.g., performance-oriented cores in three core type scenarios) based at least in part on the fourth core count (e.g., a difference between the fourth core count and the actual performance-oriented unparked cores count). In examples where there are four core types, core parking engine 104 unparks one or more performance-oriented cores based at least in part on a difference between the seventh core count and the actual performance-oriented unparked cores count, and unparks one or more enhanced performance-oriented cores based at least in part on a difference between the sixth core count and the actual performance-oriented unparked cores count.

It should be noted that the steps related to determining percentages of threads that are biased for the higher performance cores when comparing two groups of cores (e.g., comparing power efficient cores and power efficient+ cores, and comparing intermediate cores and intermediate+ cores) may instead be determining percentages of threads that are biased for the lower performance cores when comparing the two groups of cores. This determination would similarly be based on the thread policies of the threads. The determined count based on the percentages of threads would switch to the lower performance core type or type group (e.g., power efficient+, intermediate+), and the subtraction steps would yield the counts of the higher performance core type or group.

FIG. 5 illustrates an example method for heterogeneous scheduling for processors with multiple core types. The method 500 may be performed by the system(s) described herein and/or the components of such system(s). For instance, the method 500 may be performed by computing device 101 and/or the components thereof (e.g., scheduler 106).

At operation 502, a scheduler (e.g., scheduler 106) assigns a thread policy to a thread. The thread policy specifies criteria for allocation of the thread to a core of multiple heterogeneous cores of a processing system. The heterogeneous cores include one or more power efficient cores, one or more intermediate cores, one or more performance-oriented cores. In one example, the heterogeneous cores additionally or alternatively include one or more enhanced performance-oriented cores. In some examples, the criteria for the thread allocation includes a QoS level (e.g., QoS level 301, 302). Thus, the criteria for the thread allocation includes a lower threshold for heterogeneous cores, an upper threshold for heterogeneous cores, and an optimization metric. The optimization metric indicates a preferred core type or an execution bias for the thread. In some examples, the criteria for the thread allocation further includes an application type, a thread priority, an activity type, a thread category, a task size, a battery level, and/or a time deadline. An application type is a classification of an application, such as whether the application is a background service, a multimedia app, a game, or a utility. Thread priority refers to thread processing importance or timeliness and ensures that threads associated with higher-priority tasks (e.g., critical system functions) receive processing time before threads associated with lower-priority tasks (e.g., background updates). Activity type relates to a specific operation or action that the thread is designed to perform, such as reading from storage, networking, or user interface updates. Activity type is considered by scheduler 106 in determining thread allocation based on resource availability or contention. A thread category is based on the broader roles or functions of the thread, such as whether the thread is worker thread, a user interface (UI) thread, or a background thread. Task size refers to the workload or complexity of a given task. For example, threads associated with larger tasks or workloads are allocated more processing time or a higher priority, while smaller tasks or workloads are allocated less processing time or a lower priority. Battery level refers to the current battery level or charging state of computing device 101, where threads associated with power-intensive tasks are deferred or moved to other cores to conserve battery life. Time deadline refers to a specific date and/or time, or a remaining amount of time by which a task is to be completed. Scheduler 106 may be prompted to prioritize the allocation of threads that are associated with tasks that have a time deadline.

At 504, scheduler 106 allocates the thread to one of the heterogeneous cores in accordance with the thread policy assigned to the thread. In some examples, scheduler 106 determines that no cores of a preferred core type are available, and scheduler 106 allocates the thread to a different core type or does not allocate the thread.

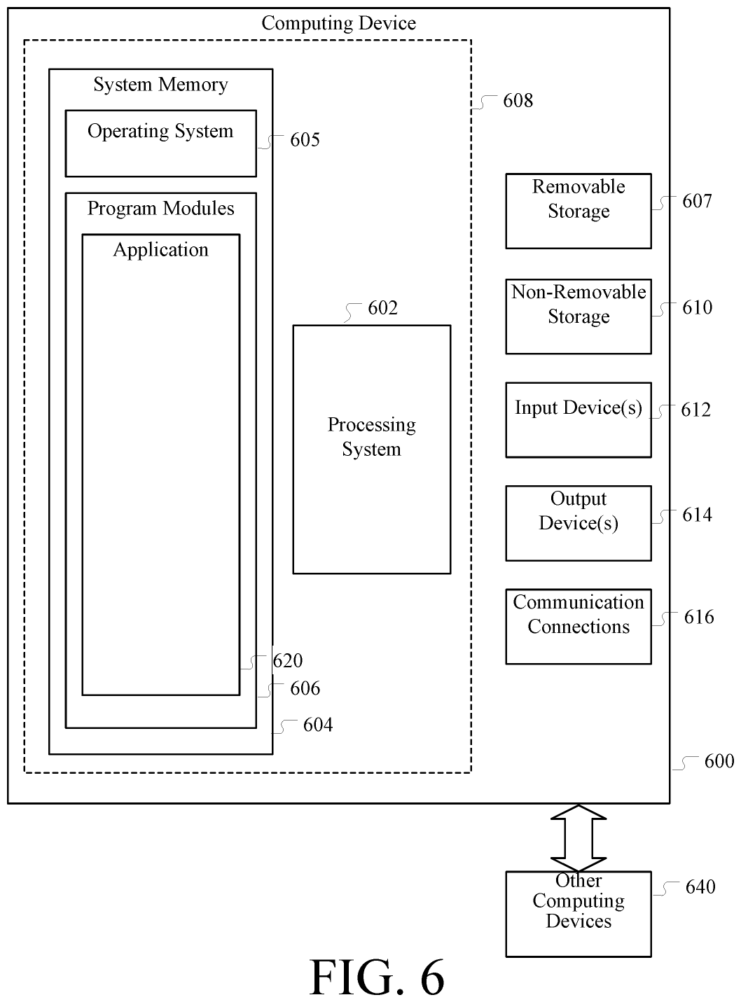

FIG. 6 is a block diagram illustrating physical components (e.g., hardware) of a computing device 600 with which aspects of the disclosure may be practiced. The computing device components described below may be suitable for the computing devices and systems described above. In a basic configuration, the computing device 600 includes at least one processing system 602 comprising processing unit(s) and a system memory 604. Depending on the configuration and type of computing device, the system memory 604 may comprise volatile storage (e.g., random access memory (RAM)), non-volatile storage (e.g., read-only memory (ROM)), flash memory, or any combination of such memories.

The system memory 604 includes an operating system 605 and one or more program modules 606 suitable for running software application 620, such as one or more components supported by the systems described herein. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, or optical disks. Such additional storage is illustrated in FIG. 6 by a removable storage device 607 and a non-removable storage device 610.

As stated above, a number of program modules and data files may be stored in the system memory 604. While executing on the processing system 602, the program modules 606 (e.g., application 620) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 640. Examples of suitable communication connections 616 include radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 607, and the non-removable storage device 610 are all computer storage media examples (e.g., memory storage). Computer storage media may include RAM, ROM, electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

As will be understood from the present disclosure, one example of the technology discussed herein relates to a system comprising: a processor; and memory comprising executable instructions that when executed, perform operations comprising: assigning a thread policy to a thread, the thread policy specifying criteria for allocation of the thread to a heterogeneous core of a plurality of heterogeneous cores of a processing system, wherein the criteria for allocation of the thread includes a lower threshold of the heterogeneous cores, an upper threshold of the heterogeneous cores, and an optimization metric, wherein the plurality of heterogeneous cores comprise one or more power efficient cores, one or more intermediate cores, and one or more performance-oriented cores; and allocating the thread to one of the heterogeneous cores and in accordance with the thread policy assigned to the thread.

In another example, the technology discussed herein relates to a system comprising: a processor; and memory comprising executable instructions that when executed, perform operations comprising: analyzing one or more system utilization metrics; determining a first core count based at least in part on analyzing the one or more system utilization metrics, wherein the first core count represents a total number of cores to be unparked; determining a second core count, wherein the second core count represents a number of cores to be unparked that are higher performance than power efficient cores; determining a third core count by subtracting the second core count from the first core count, wherein the third core count represents a number of cores to be unparked that are power efficient cores; determining a fourth core count, wherein the fourth core count represents a number of cores to be unparked that are higher performance than intermediate cores; determining a fifth core count by subtracting the fourth core count from the second core count, wherein the fifth core count represents a number of cores to be unparked that are intermediate cores; and unparking one or more cores based at least in part on the third core count, the fourth core count, and the fifth core count.

In another example, the technology discussed herein relates to a method comprising: determining an actual performance-oriented unparked cores count; and determining an actual enhanced performance-oriented unparked cores count, wherein the unparking the one or more cores with higher performance than intermediate cores based at least in part on the fourth core count comprises: unparking one or more performance-oriented cores based at least in part on a difference between the seventh core count and the actual performance-oriented unparked cores count; and unparking one or more enhanced performance-oriented cores based at least in part on a difference between the sixth core count and the actual performance-oriented unparked cores count.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a processor; and
memory comprising executable instructions that, when executed, perform operations comprising:
analyzing a plurality of system utilization metric;
determining a first core count based at least in part on analyzing the plurality of system utilization metric, wherein the first core count represents a total number of processor cores to be unparked;
determining a second core count, wherein the second core count represents a number of cores to be unparked that are higher performance than power efficient cores;
determining a third core count by subtracting the second core count from the first core count, wherein the third core count represents a number of cores to be unparked that are power efficient cores;
determining a fourth core count, wherein the fourth core count represents a number of cores to be unparked that are higher performance than intermediate cores;
determining a fifth core count by subtracting the fourth core count from the second core count, wherein the fifth core count represents a number of cores to be unparked that are intermediate cores; and
unparking a core based at least in part on the third core count, the fourth core count, and the fifth core count.

2. The system of claim 1, further comprising:
determining, from a plurality of threads, a first percentage of threads of the plurality of threads that have thread policies biased for cores that are higher performance than power efficient cores, wherein determining the second core count is based at least in part on determining the first percentage of threads;
determining, from the first percentage of threads, a second percentage of threads of the first percentage of threads that have thread policies biased for cores that are higher performance than intermediate cores, wherein determining the fourth core count is based at least in part on determining the second percentage of threads; and
determining an actual power efficient unparked cores count and an actual intermediate unparked cores count;
wherein unparking the core comprises:
unparking a power efficient core based at least in part on a difference between the third core count and the actual power efficient unparked cores count;
unparking an intermediate core based at least in part on a difference between the fifth core count and the actual intermediate unparked cores count; or
unparking a core with higher performance than intermediate cores based at least in part on the fourth core count.

3. The system of claim 2, wherein the cores that are higher performance than intermediate cores are performance-oriented cores.

4. The system of claim 3, the operations further comprising:
determining an actual performance-oriented unparked cores count,
wherein the unparking the core with higher performance than intermediate cores based at least in part on the fourth core count comprises:
unparking a performance-oriented core based at least in part on a difference between the fourth core count and the actual performance-oriented unparked cores count.

5. The system of claim 3, wherein cores that are higher performance than power efficient cores comprise intermediate cores and performance-oriented cores.

6. The system of claim 2, the operations further comprising:
determining, from the second percentage of threads, a third percentage of threads of the second percentage of threads that have thread policies biased for enhanced performance-oriented cores;
determining a sixth core count based at least in part on determining the third percentage of threads, wherein the sixth core count represents a number of cores to be unparked that are enhanced performance-oriented cores;
determining a seventh core count by subtracting the sixth core count from the fourth core count, wherein the seventh core count represents a number of cores to unpark that are performance-oriented cores.

7. The system of claim 6, the operations further comprising:
determining an actual performance-oriented unparked cores count; and
determining an actual enhanced performance-oriented unparked cores count,
wherein the unparking the core with higher performance than intermediate cores based at least in part on the fourth core count comprises:
unparking a performance-oriented core based at least in part on a difference between the seventh core count and the actual performance-oriented unparked cores count; and
unparking an enhanced performance-oriented core based at least in part on a difference between the sixth core count and the actual performance-oriented unparked cores count.

8. The system of claim 6, wherein cores that are higher performance than intermediate cores comprise performance-oriented cores and enhanced performance-oriented cores.

9. The system of claim 1, wherein a total core count for the system is the first core count in addition to a parked core count.

10. The system of claim 1, wherein the plurality of system utilization metrics comprises at least one of: a workload, concurrency data, a runqueue length, a power plan setting, a battery state, a user input, a system temperature, a core clock speed, or a hardware hint.

11. A system comprising:
a processor; and
memory comprising executable instructions that when executed, perform operations comprising:
assigning a thread policy to a thread, the thread policy specifying criteria for allocation of the thread to a heterogeneous core of a plurality of heterogeneous processor cores of a processing system, wherein criteria for allocation of the thread includes a lower threshold of the plurality of heterogeneous processor cores, an upper threshold of the plurality of heterogeneous processor cores, and an optimization metric, wherein the plurality of heterogeneous processor cores comprise a power efficient core, an intermediate core, and a performance-oriented core; and
allocating the thread to one of the plurality of heterogeneous processor cores and in accordance with the thread policy assigned to the thread.

12. The system of claim 11, wherein the optimization metric indicates whether the thread has an execution bias toward power efficient cores or performance-oriented cores.

13. The system of claim 11, wherein the thread policy includes a quality of service (QOS) metric.

14. The system of claim 11, wherein the lower threshold designates the power efficient core, the upper threshold designates the intermediate core, and the optimization metric indicates an execution bias towards power efficient cores, wherein allocating the thread comprises:
allocating the thread to the power efficient core based at least in part on the thread policy of the thread.

15. The system of claim 11, wherein the lower threshold designates the power efficient core, the upper threshold designates the intermediate core, and the optimization metric indicates an execution bias towards power efficient cores, the operations further comprising:
determining that the power efficient core is not available, wherein allocating the thread comprises:
allocating the thread to the intermediate core based at least in part on the thread policy of the thread and determining that the power efficient core is not available.

16. The system of claim 11, wherein the lower threshold designates the power efficient core, the upper threshold designates the performance-oriented core, and the optimization metric indicates an execution bias towards performance-oriented cores, wherein allocating the thread comprises:
allocating the thread to the performance-oriented core based at least in part on the thread policy of the thread.

17. The system of claim 11, wherein the lower threshold designates the power efficient core, the upper threshold designates the performance-oriented core, and the optimization metric indicates an execution bias towards performance-oriented cores, the operations further comprising:
determining that the performance-oriented core is not available, wherein allocating the thread comprises:
allocating the thread to the intermediate core based at least in part on the thread policy of the thread and determining that the performance-oriented core is not available.

18. The system of claim 11, wherein the criteria for allocation of the thread include at least one of: an application type, a thread priority, an activity type, a thread category, a task size, a battery state, or a time deadline.

19. The system of claim 11, wherein the plurality of heterogeneous processor cores additionally comprises an enhanced performance-oriented core.

20. A method comprising:
determining a first count of first processor cores to be unparked;
determining a second count of second processor cores to be unparked, the second processor cores to be unparked being a first subset of the first processor cores to be unparked;
determining a third count of third processor cores to be unparked for a first processor core type, the third processor cores to be unparked being a second subset of the first processor cores to be unparked;
determining a fourth count of fourth processor cores to be unparked for a second processor core type, the fourth processor cores to be unparked being a third subset of the second processor cores to be unparked;
determining a fifth count of fifth processor cores to be unparked for a third processor core type, the fifth processor cores to be unparked being a fourth subset of the second processor cores to be unparked;
unparking at least one of the third processor cores to be unparked based at least in part on the third count;
unparking at least one of the fourth processor cores to be unparked based at least in part on the fourth count;
unparking at least one of the fifth processor cores to be unparked based at least in part on the fifth count; and
allocating threads on a thread-by-thread basis among at least a portion of the at least one third processor cores having been unparked, the at least one fourth processor cores having been unparked, and the at least one fifth processor cores having been unparked in accordance with thread policies assigned to the threads.
